(19) United States
(12) Patent Application Publication
(10) Pub. No.: US 2009/0208844 A1
(43) Pub. Date: Aug. 20, 2009

(54) Secondary battery material

(76) Inventors: Keith D. Kepler, Belmont, CA (US); Yu Wang, Foster City, CA (US); Hongjian Liu, Hercules, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/315,809

(22) Filed: Dec. 4, 2008

Related U.S. Application Data
(60) Provisional application No. 61/005,433, filed on Dec. 4, 2007.

(51) Int. Cl. H01M 4/58; H01M 4/26

(52) U.S. Cl. 429/218.1; 427/122

(57) ABSTRACT

Embodiments of the invention relate to materials used in secondary batteries and the method for manufacturing the same. To address the problems of the prior art, an object of the present invention is to provide a negative electrode material for a non-aqueous Li-ion cell comprising active component particles capable of reversibly intercalating or alloying with lithium ions with a carbon coating layer containing an electronically conductive, elastic, carbon material capable of reversibly expanding and contracting to maintain electrical contact between the particles within an electrode matrix as the material is cycled electrochemically. Accordingly, several objects and advantages of embodiments of the invention include improved cycle life of high capacity active materials suitable for use in secondary batteries and the high capacity, long life cells.

### CROSS REFERENCE TO RELATED APPLICATION

This application claims priority from Provisional Patent Application No. U.S. 61/005,433, filed Dec. 4, 2007, entitled Secondary Battery Material. U.S. Provisional Application No. 61/055,433 is incorporated herein by reference.

### FIELD

Embodiments of the invention relate to materials used in secondary batteries and the method for manufacturing the same.

### BACKGROUND

The development of low cost, safer, higher energy and power density rechargeable batteries is critical for the commercial introduction of a number of advanced technologies addressing the needs of a wide range of markets within the automotive industry, telecommunications industry, and the military. Commercial, lithium-ion based rechargeable battery technology currently provides the greatest energy density but still falls short of the cost, energy and power requirements of new applications such as electric vehicles (EV/HEV's), web-enabled cell phones, and other advanced portable power applications. To address the limitations of current Li-ion systems a significant amount of research has focused on the development of alternatives to the current cathode and anode Li-ion intercalation materials: LiCoO₂ and Graphitic Carbon respectively. This includes several families of ultra-high energy density Li-ion intermetallic anode materials (ex. Al, Si, Sn, Cu—Sn, etc) which have the potential of providing up to 4 times the energy density of graphitic carbon. These intermetallic anodes could potentially lead to much more economical batteries on a $/Wh basis, both due to the increase in the total cell energy density and to potential safety improvements gained from operating at negative voltages further away from the Lithium metal deposition potential. Furthermore, Li-ion diffusion within these materials is often similar to that in graphitic carbon allowing for high power cell designs.

While promising in theory, most of the intermetallic systems suffer from excessive volumetric expansion as Lithium ions are cycled in and out of the materials. For example, while graphitic carbon will expand less than 3%, fully lithiated silicon will occupy more than four times the volume of elemental silicon. This massive volumetric change during cycling can result in pulverization of the particles and/or loss of electrical contact of the particles within the electrode PVDF/carbon-black laminate matrix. Thus the practical reversibility and cycle life of these materials is typically very poor. However, through extensive engineering of intermetallic based anodes, several groups have demonstrated greatly improved cycle life, roughly matching that for graphite. The most technically successful approaches, involving thin, solid-film deposition work because they provide a mechanism to maintain electrical contact to each individual intermetallic particle as it is cycled, despite the large volumetric change. Unfortunately, the thin film approach is expensive and is not compatible with current Li-ion manufacturing technology and cell designs because the materials cannot be produced in powdered form without losing their cycling advantage. Thus they are unlikely to result in commercial products.

The theoretical energy density of most intermetallic anode materials is quite high when compared to carbon. For example, when fully lithiated to Li_{4.4}Si the energy density of silicon is calculated to be 4200 mAh/g. In fact, even when only partially lithiated (ex, Li_{1.71}Si-1630 mAh/g), Silicon has the greatest theoretical energy density of the intermetallic materials. This compares quite favorably to carbon, which has a theoretical capacity of only 370 mAh/g. Unfortunately, this massive capacity for Li comes at a price, which is the huge volume difference between the elemental and lithiated materials.

This volume change during lithiation is the primary reason that the cycle life of these materials has been severely limited in the past. To some extent, this can be mitigated by limiting the extent of lithiation of the intermetallic anode. However, this is an undesirable approach, both because you begin to lose the capacity advantage you have over other materials and because it is often difficult to design into a Li-ion cell. Thus, ideally to use these materials, methods must be identified and developed to carefully design or engineer them in a manner that limits the detrimental effects of excessive volumetric expansion. Nanoparticulate materials have been developed to mitigate this problem but those materials typically have large irreversible capacity losses due to the large surface area and they are often difficult to handle in a large scale battery manufacturing environment.

Various groups have developed and evaluated several other methods to improve the cycle life of intermetallic anode materials. The main approaches can be placed into three broad categories.

1. Creation of composites with other active or inactive species.

2. Coating active particles with a conductive material.

3. Deposition of thin films of active intermetallic anode material directly onto the current collector.

Each technique has been reported to improve the performance of intermetallic anodes in some manner. The approaches are described in more detail below using silicon for specific examples.

Composites:

A range of composites of most elemental intermetallic anode materials have been evaluated as improved anodes for Li-ion batteries. (J. O. Besenhard, M. H., P. Komenda, Dimensionally Stable Li-Alloy Electrodes For Secondary Batteries. Solid State Ionics, 1990. 40/41: p. 525-529.) Silicon-metal composites have recently been made by ball-milling silicon with an inactive metal such Ag. (Hwang, S.-M., et al., Lithium insertion in SiAg powders produced by mechanical alloying. Electrochemical and Solid-State Letters, 2001. 4(7): p. A97-A100). During lithiation, the alloy will break down into intimately mixed nano-phase Si/LiSi within a conductive metal matrix. The problems with these materials include poor kinetics, slow recrystallization of the Si into larger and larger grains, which on further cycling become electrically isolated from the conductive matrix. The conductive matrix is not very elastic and the volumetric changes of the active Silicon have the same problems described above for Silicon electrode laminates. In general, most composite anode intermetallic materials still undergo unacceptably large volumetric expansion and do not cycle sufficiently well for commercial applications.

Coating:

Another approach that has shown promise for improving the cycle life of intermetallic anode powders is to coat the individual particles with a layer of conductive carbon. The primary methods used to coat Silicon include: thermal vapor deposition (TVD) [Yoshio, M., et al., Carbon-coated Si as a lithium-ion battery anode material. Journal of the Electrochemical Society, 2002. 149(12): p. A1598-A1603.] solution, [Yang, J., et al., Si/C Composites for High Capacity Lithium Storage Materials. Electrochemical and Solid-State Letters, 2003. 6(8): p. A154-A156] or pitch-melt [Wilson, A. M., et al., Pyrolyzed pitch-polysilane blends for use as anode materials in lithium ion batteries II: the effect of oxygen. Solid State Ionics, 1997. 100(3, 4): p. 259-266] processes at temperatures below ˜1500° C. (at which point inactive SiC forms). Along with improving cycle life, coating Silicon with carbon has the added benefit that the initial irreversible capacity is greatly decreased due to removal of the surface oxide coating on Silicon during the coating process. The coated Silicon is also protected from further oxidation and contamination by the carbon coating. Improved cycling performance has been ascribed to improved particle-to-particle contact and surface conductivity and also to the prevention of the nano-particle silicon from annealing into larger particles during cycling. A number of other intermetallic anode materials have been improved by coating with carbon. (Ulus, A., et al., Tin alloy-graphite composite anode for lithium-ion batteries. Journal of the Electrochemical Society, 2002. 149(5): p. A635-A643.) Though the coating approach can greatly improve the initial irreversible capacity loss, these types of coatings do not appear to prevent ongoing loss of lithium to the point that a commercially viable product can be produced. This is since the carbon coating will not solve the issue of particle isolation due to large volumetric changes within the anode laminate.

Thin Intermetallic Films:

Another successful method for engineering intermetallic anodes is to deposit thin films of silicon directly onto the copper current collector. Several groups have used this approach, both for Silicon [Ikeda, H., et al., Lithium battery anodes and secondary lithium batteries, in PCT Int. Appl. 2001, (Sanyo Electric Co., Ltd., Japan). Wo. p. 85] and other intermetallic systems (U.S. Pat. No. 6,436,578 B2 (2002); J. O. Besenhard, K. C. M., A. Trifonova, M. Wachtler, M. R. Wagner and M. Winter. Lithium Storage Metal and Alloy Anodes in Lithium Ion Batteries-Prospects and Problems. in IMLB 11. 2002. Monterey, Calif.), with some of the best cycling performance for Silicon reported by Sanyo. The irreversible capacity loss is generally low in part because the films are made in vacuum and there is also very little surface area exposed before the cell is cycled. Excellent reversibility has been demonstrated, even in full cells where the amount of Lithium is limited by the cathode. Unfortunately the system is not currently compatible with large scale Li-ion manufacturing processes, and it is unlikely that the approach can be used for anything outside of niche markets because of its cost. However, these results demonstrate that intermetallic anode materials can be used as an anode to make high capacity Li-ion cells if the materials can be engineered correctly. An alternative approach is needed that is low cost and produces a powdered material compatible with current Li-ion manufacturing processes.

In conclusion, no method has been developed to date to allow high capacity rechargeable battery active materials that typically go through large volumetric changes during cycling, to be used in a practical manner, thus limiting the maximum capacity of Li-ion cells.

### SUMMARY

To address the problems of the prior art, an object of the present invention is to provide a negative electrode material for a non-aqueous Li-ion cell comprising active component particles capable of reversibly intercalating or alloying with lithium ions with a carbon coating layer containing an electronically conductive, elastic, carbon material capable of reversibly expanding and contracting to maintain electrical contact between the particles within an electrode matrix as the material is cycled electrochemically.

According to one embodiment, the weight ratio of the active component to the carbon coating layer may be from 55:45 to 95:5, and preferably 60:40 to 92:8.

The active component may be any active component conventionally used as an anode in a Li-ion cell. However, it is preferable that the active component of this invention be one in which its capability of providing a very high energy density is accompanied by large volumetric changes. More preferably, the active component is Si, Al, Sn, Pb, or alloys or intermetallic compositions comprising one of these elements. Even more preferably, the active component has a melting point greater than 800° C. The active component is most preferably silicon.

The conductive and elastic material is preferably an expanded carbonaceous material, and more preferably expanded graphite due to its low cost, good conductivity, and excellent ability of reversibly expanding and contracting.

The active component particles may have an average particle size between 0.05 and 25 um, and preferably between 0.1 and 10 um.

The carbon coating layer may further contain pyrolyzed carbon. The weight ratio of the electronically conductive, elastic, carbon material to the pyrolyzed carbon may be from 1:0.2 to 1:5.

Another object of the present invention is to provide a secondary Li-ion cell that uses the negative electrode material according to the present invention. The other elements of the second Li-ion cell may be those conventionally used in the art.

Still another object of the present invention is to provide a process for making the negative electrode material powder according to the present invention, comprising the step of coating the active component particles capable of reversibly intercalating or alloying with lithium ions with the carbon coating layer containing an electronically conductive, elastic, carbon material capable of reversibly expanding and contracting to maintain electrical contact between the particles within an electrode matrix as the material is cycled electrochemically.

In a first preferred embodiment, the step of coating the active component particles with the carbon coating layer may include at least the following sub-steps:

(1) Mixing the active component particles with a carbon containing material;

(2) Firing the mixture to carbonize the carbon containing material; and

(3) Expanding the carbonized material.

In step (1), the active component particles are coated with the carbon containing material. The weight ratio of the active component particles to the carbon containing material is such that the weight ratio of the active component to the carbon containing layer may be from 55:45 to 95:5, and preferably 60:40 to 92:8. The active component particles may be prepared by the known method in the art or purchased commercially.

In step (2), the firing may be performed at a temperature below the decomposition or melting point of the active component but above the carbonization point of the carbon containing material, preferably at a temperature of 900 to 1100° C. The firing may be performed for 20 min to 2 hr, preferably 30 min to 60 min at the target temperatures. The firing is preferably performed in inert atmosphere selected from one or more gases unreactive with reactants or reaction product, such as one or more of argon, nitrogen, and Group 0 gases

In step (3), the carbonized material may be expanded by intercalating species into the carbon followed by heating and vaporization. Two processes can be used to produce expanded carbonaceous material from the carbonized material including first intercalation of a species into the carbonized material and then heating at ˜800-1000° C. for 2 min to 10 min to expand the carbonized material. The material is usually washed after intercalation and possibly after the expansion process. There are several methods to do the intercalation reaction, the most common being either electrolytic intercalation in an electrochemical cell or oxidative intercalation using an appropriate oxidizer such as concentrated sulfuric acid, concentrated nitric acid, mixture of concentrated sulfuric acid and concentrated nitric acid, concentrated chromic acid, potassium chromate, perchloric acid etc. The most common intercalating agent is sulfate from concentrated sulfuric acid to produce graphite bisulfate.

In a second preferred embodiment, the step of coating the active component particles with the conductive and elastic material may include at least the following sub-steps:

(1) Physically mixing the active component particles, the already expanded carbonaceous material and a carbon containing material; and

(2) Firing the mixture to carbonize the carbon containing material.

In this embodiment, the already expanded carbonaceous material may be prepared by the known method in the art, such as the method described in the first embodiment in which an expanded carbonaceous material may be produced by intercalating species into a carbonaceous material followed by heating and vaporization, or purchased commercially. The already expanded carbonaceous material is preferably at least partially graphitic, and more preferably expanded graphite.

The weight ratio of the active component: the already expanded carbonaceous material: a carbon containing material is such that the weight ratio of the active component to the carbon coating layer may be from 55:45 to 95:5, and preferably 60:40 to 92:8. Preferably, the weight ratio of the already expanded carbonaceous material to the carbon containing material may be from 1:0.2 to 1:5.

In step (2), the firing may be performed according to the same manner as the step (2) of the first embodiment.

In a third preferred embodiment, the step of coating the active component particles with the conductive and elastic material may include at least the following sub-steps:

(1) Physically mixing the active component particles, a pre-intercalated carbonaceous material and a carbon containing material; and

(2) Firing the mixture to simultaneously carbonize the carbon containing material and expanding the intercalated carbonaceous material.

In this embodiment, the pre-intercalated carbonaceous material may be prepared by the known method in the art, such as the method described in the first embodiment in which an intercalated carbonaceous material may be produced by intercalating species into a carbonaceous material followed by heating and vaporization, or purchased commercially. The pre-intercalated carbonaceous material is preferably intercalated graphite (also referred to as expandable graphite).

The weight ratio of the active component:the pre-intercalated carbonaceous material:a carbon containing material is such that the weight ratio of the active component to the carbon coating layer may be from 55:45 to 95:5, and preferably 60:40 to 90:10. Preferably, the weight ratio of the pre-intercalated carbonaceous material to the carbon containing material may be from 1:0.2 to 1:5. The pre-intercalated carbonaceous material is preferably at least partially graphitic, and more preferably pre-intercalated graphite.

In step (2), the firing and expanding may be performed according to the same manner as the first embodiment.

In the first, second or third embodiment, the carbon containing material may be carbon pitch or a carbon based polymer. The carbon based polymer includes, but is not limited to, terpolymer of benzene, naphthalene and phenanthrene, binary copolymer of benzene and phenanthrene, binary copolymer of benzene and anthracene, polyvinyl alcohol, starch, dextrin, phenolic resin, and furfural resin.

Accordingly, several objects and advantages of the invention include improved cycle life of high capacity active materials suitable for use in secondary batteries and the high capacity, long life cells. The conductive and elastic material such as expanded graphite allows the individual active material particles to remain in contact with the surrounding conductive laminate matrix through large volumetric changes. The coating of the conductive and elastic material reduces the initial irreversible loss by eliminating oxide species inherent to the active material powder and protecting it during exposure to air before being sealed in the battery. The final material is in a powdered form that is easily coated to make electrode laminates. The coating process is flexible and compatible with a number of battery active materials.

Other features and advantages of embodiments of the present invention will be apparent from the accompanying drawings and from the detailed description that follows below.

### BRIEF DESCRIPTION OF THE DRAWINGS

Embodiments of the present invention are illustrated by way of example and not limitation in the figures of the accompanying drawings, in which like references indicate similar elements and in which:

FIG. 1: SEM pictures of generic expanded graphite material as used in Example 1 and Example 2. A) Graphite flakes before expansion B) Graphite after expansion process. C) Close up of graphite after expansion process.

FIG. 2: Illustration of active material particle coated with expanded graphite.

FIG. 3: Illustration of how expanded graphite behaves like a spring contact between individual particles in an electrode during cycling. A) X-Y flexibility of expanded graphite particle attached to Silicon surface. B) Z-axis compressibility of expanded graphite attached to Silicon surface. C) Interaction of expanded graphite coated Silicon particles during charge and discharge.

FIG. 4: Illustration of expanded graphite coating maintaining electrical contact with the conductive laminate during cycling and volumetric expansion and contraction.

FIG. 5: Diagram of general process for coating active material with expanded graphite.

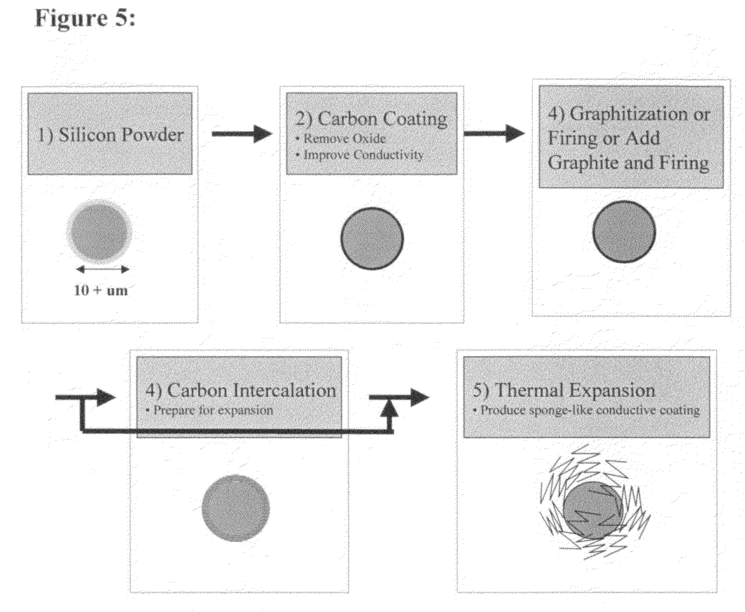

FIG. 6: Cycling efficiency data for Li-ion cell prepared from composite expanded graphite silicon materials prepared by firing silicon, expanded graphite and carbon pitch compared to carbon coated silicon and silicon baseline.

FIG. 7: Cycling efficiency data for composite expanded graphite silicon materials prepared by firing a mixture of intercalated graphite, silicon and carbon pitch.

Reference Numerals:
11-Active component particle
12-Expanded graphite particle
13-Electrode laminate matrix.

### DETAILED DESCRIPTION

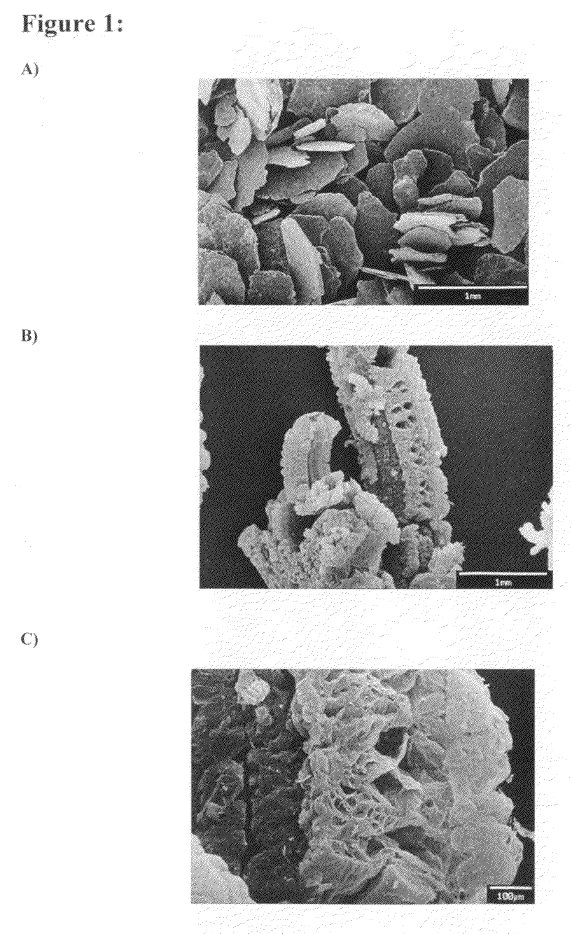

FIG. 1 shows SEM images of typical graphite before and after the expansion process. Expanded graphite is a well-known material, usually made by a two-step process that involves the oxidative or electrochemical intercalation of a species into the layers of a graphitized carbon followed by a heating step that vaporizes or decomposes the species. The gaseous expansion of the intercalated species within the layers pushes apart the individual graphitic sheets producing a lower density, accordion-appearing particle with spring-like properties.

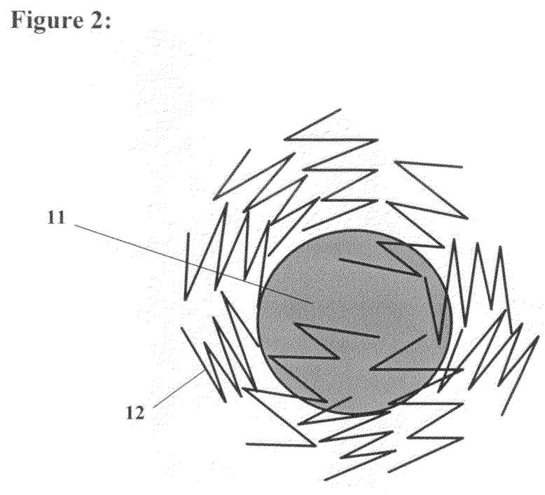

FIG. 2 shows an illustration of the active component particle 11, coated with the expanded graphite material 12.

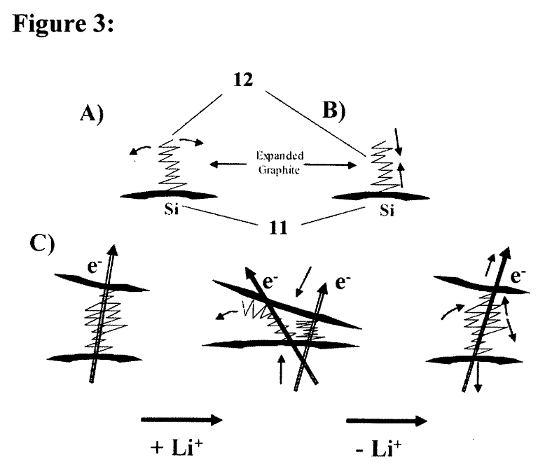

FIG. 3 shows an illustration of how the expanded graphite 12, will act as springs in the x-y and z directions to maintain electrical contact among the individual active component particles in an electrode laminate as the active material expands and contracts during cycling as Li goes in and out of the active component.

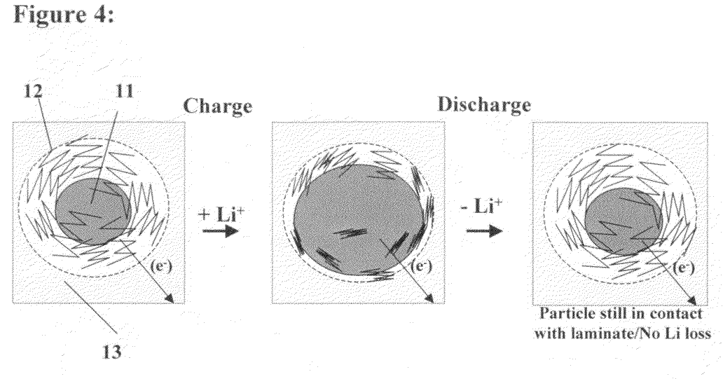

FIG. 4 shows another illustration of how the expanded graphite 12, will maintain electrical contact, which is critical to reversibly cycle the active component particles, to the electrode conductive laminate 13, during expansion and contraction. It could be seen from the FIG. 4 that, after a cycle of charging and discharging, the active component particles are still in contact with laminate and there is no Li loss, regardless of volumetric changes of the active component particles.

### EXAMPLES

### Example 1

Expanded Graphite Silicon Composite Materials with Pre-Expanded Graphite Added

The expanded graphite silicon composite materials using pre-expanded graphite were prepared by conventional solid state methods. Silicon powder (Si, Aldrich, <30 um) and carbon pitch powder (CP) was pre-mixed with specific weight percentages, 88% Si-12% CP, and 92% Si-8% CP, respectively, for 12 hrs (Wheaton Modular Cell Production Roller Apparatus, Model III).

Each of the above mixtures were further divided into two, and mixed with expanded graphite (EG, Asbury) following the weight percentages, 10% EG, and 3% EG, respectively (respective to Si-CP mixture as 100% by weight). These four final Si-CP-EG mixtures (Sample 1-Sample 4, see Table 1 for details), i.e., (88% Si-12% CP)3% EG, (88% Si-12% CP)10% EG, (92% Si-8% CP)3% EG, and (92% Si-8% CP)10% EG, were fired at 7° C./min from room temperature to 1100° C. in Ar (CM Furnace 1218), holding for 1 hr. The process was denoted as One-step Firing.

The above fired materials were sieved through 53-90 um screens (Octagon 200 Test Sieve Shaker). Electrodes were then prepared using 83% active materials, 10% PVDF binder (Solvey) and 7% carbon black (Osaka Gas), forming a slurry with NMP and then coating the slurry onto Cu foil. Electrodes were punched from these coatings and CR2032 type coin cells were built using lithium foil as the counter electrode, a porous PE separator and 1 M LiPF₆ EC/DEC (Ethylene Carbonate/Diethyl Carbonate) as the electrolyte. Electrochemical valuations were carried out using these built CR2032 coin cells (CT2001A, LAND Battery Test System, Kingnuo Electronic Co., Ltd.).

### Example 2

Expanded Graphite Silicon Composite Materials with Pre-Expanded Graphite Added

The expanded graphite silicon composite materials using pre-expanded graphite were prepared by conventional solid state methods. Silicon powder (Si, Aldrich, <30 um) and carbon pitch powder (CP) was pre-mixed with specific weight percentages, 88% Si-12% CP, and 92% Si-8% CP, respectively, for 12 hrs (Wheaton Modular Cell Production Roller Apparatus, Model III).

Each of the above pre-mixed Si-CP mixtures were first fired at 2° C./min from room temperature to 400° C. in Ar, holding for 1 hr; then cooled down to room temperature (pre-heating). The pre-heated mixtures of each of SI-CP mixtures were divided into two, and then mixed with expanded graphite (EG) following the same EG weight percentages as that in one-step fired samples of Example 1. These four Si-CP-EG mixtures (Sample 5-Sample 8, see Table 1 for details) were finally fired at 7° C./min from room temperature to 1100° C. in Ar (CM Furnace 1218), holding for 1 hr (final-firing). The above entire process was denoted as Two-step Firing.

CR2032 type coin cells were built using the above fired materials and electrochemical valuations were carried out according to the same methods as described in Example 1.

TABLE 1
Expanded graphite silicon composite materials using pre-
expanded graphite

| | | | Composition of the final | | |
|---|---|---|---|---|---|
| | | | material | | |
| | | Firing | Si | | |
| Example | Sample | Condition | % wt | CP % wt | EG % wt |
| Example 1 | Sample 1 | One-step Firing | 85.44 | 11.65 | 2.91 |
| | Sample 2 | One-step Firing | 80.00 | 10.91 | 9.09 |
| | Sample 3 | One-step Firing | 89.32 | 7.77 | 2.91 |
| | Sample 4 | One-step Firing | 83.64 | 7.27 | 9.09 |
| Example 2 | Sample 5 | Two-step Firing | 85.44 | 11.65 | 2.91 |
| | Sample 6 | Two-step Firing | 80.00 | 10.91 | 9.09 |
| | Sample 7 | Two-step Firing | 89.32 | 7.77 | 2.91 |
| | Sample 8 | Two-step Firing | 83.64 | 7.27 | 9.09 |

### Example 3

Expanded Graphite Silicon Composite Materials with Pre-Intercalated Graphite Added

The expanded graphite silicon composite materials using intercalated graphite were prepared by the same solid state methods as descript in Example 1. Silicon powder (Si, Alfa Aesar, 0.05-5 um), pre-intercalated graphite (IG, Asbury), and carbon pitch powder (CP) was mixed with specific weight percentages, 92% Si-8% CP-10% IG, for 12 hrs (Wheaton Modular Cell Production Roller Apparatus, Model III). The above mixed mixture was then divided to three, and pre-heated at 4° C./min from room temperature to 300, 350, and 400° C., respectively (denoted as Sample 9, Sample 10, and Sample 11, see Table 2 for details), then cooled down to room temperature. The pre-heated mixtures were then finally fired at 7° C./min from room temperature to 1100° C. in Ar (CM Furnace 1218), holding for 1 hr.

CR2032 type coin cells were built using the above fired materials and electrochemical valuations were carried out according to the same methods as described in Example 1.

### Example 4

Expanded Graphite Silicon Composite Materials with Pre-Intercalated Graphite Added

Another sample, Sample 12, was made with the same composition as Sample 9-11. But the mixture of silicon and intercalated graphite (92% Si-10% IG) was pre-heated at 4° C./min from room temperature to 300° C. Then carbon pitch was added to the pre-heated mixture of silicon and intercalated graphite, following 92% Si-8% CP-10% IG. This mixture was then fired at 7° C./min from room temperature to 1100° C. in Ar (CM Furnace 1218), holding for 1 hr.

CR2032 type coin cells were built using the above fired materials and electrochemical valuations were carried out according to the same methods as described in Example 1.

TABLE 2
Expanded graphite silicon composite materials using intercalated
graphite

| | | | Composition of the final | | |
|---|---|---|---|---|---|
| | | Firing | material | | |
| Example | Sample | Condition | Si % wt | CP % wt | IG % wt |
| Example 3 | Sample 9 | w/ 300° C. pre- | 83.64 | 7.27 | 9.09 |
| | | heating | | | |
| | Sample | w/ 350° C. pre- | 83.64 | 7.27 | 9.09 |
| | 10 | heating | | | |
| | Sample | w/ 400° C. pre- | 83.64 | 7.27 | 9.09 |
| | 11 | heating | | | |
| Example 4 | Sample | w/ 400° C. pre- | 83.64 | 7.27 | 9.09 |
| | 12 | heating | | | |

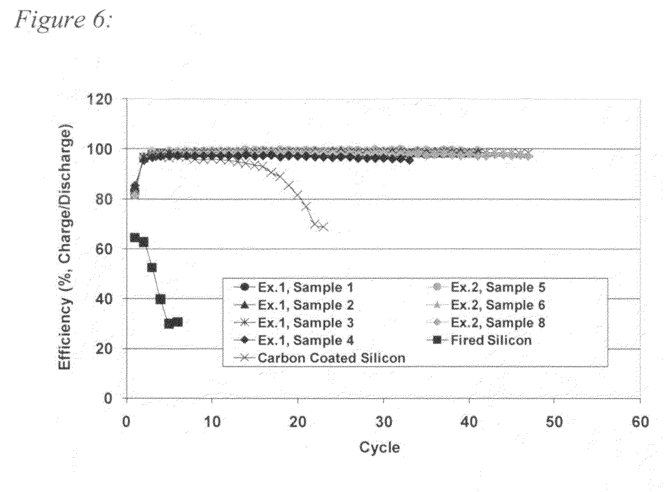

FIG. 6 shows plots of efficiency vs cycle number for capacity limited cycling at 500 mAh/g for active materials of expanded graphite silicon composite materials made from pre-expanded graphite. Data from carbon coated silicon and standard silicon (Si, Aldrich) is also shown, wherein carbon coated silicon is prepared by firing silicon and carbon pitch mixture at 1100° C. for 1 hr. We observed a clear beneficial effect from the composite expanded graphite silicon structure for all of the variations. Not only did the average cycling efficiency increase to >99%, but it maintained that level for a much longer period with most of the cells still cycling even now. We believe that this is a result of the special ability of the expanded graphite to absorb at least some of the volumetric expansion of the silicon particles and of the carbon coating to maintain contact between the expanded graphite and the silicon despite the stresses formed between the particles.

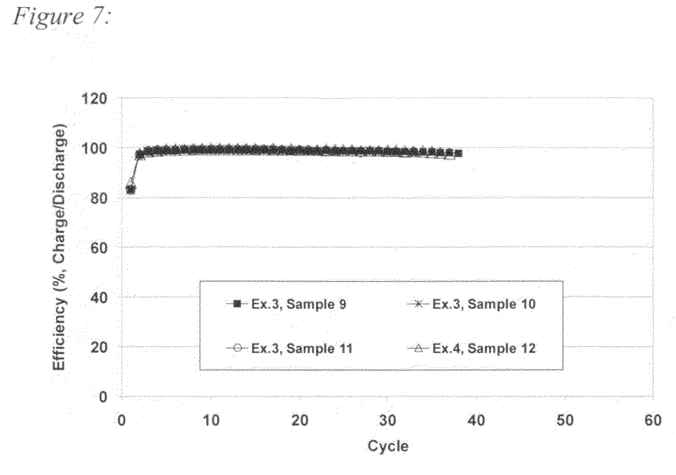

FIG. 7 shows data for cycling for a composite material made by mixing intercalated graphite with silicon powder and carbon pitch before firing at 1100° C. The cycling efficiency of the composite material is greatly improved over a simple mixture of silicon and expanded graphite or of carbon coated silicon.

While the invention is described through the above exemplary embodiments, it will be understood by those of ordinary skill in the art that modification to and variation of the illustrated embodiments may be made without departing from the inventive concepts herein disclosed. Accordingly, the invention should not be viewed as limited except by the scope and spirit of the appended claims.

What is claimed is:

1. A negative electrode material for a non-aqueous Li-ion cell comprising active component particles capable of reversibly intercalating or alloying with lithium ions with a carbon coating layer containing an electronically conductive, elastic, carbon material capable of reversibly expanding and contracting to maintain electrical contact between the particles within an electrode matrix as the material is cycled electrochemically.

2. The material of claim 1 in which the active component is Si, Al, Sn, Pb, or alloys or intermetallics containing these elements that are capable of reversibly intercalating or alloying with lithium ions.

3. The material of claim 2 in which the active component has a melting point greater than 800° C.

4. The material of claim 3 in which the active component is silicon.

5. The material in claim 1 in which the conductive, elastic, carbon material is an expanded carbonaceous material.

6. The material of claim 5 in which the expanded carbonaceous material is expanded graphite.

7. The material of claim 1 in which the active component particles have an average particle size between 0.05 and 25 um.

8. The material of claim 1 in which the weight ratio of the active component to the carbon coating layer is from 55:45 to 95:5.

9. The material of claim 8 in which the active component is Si, Al, Sn, Pb, or alloys or intermetallics containing these elements that are capable of reversibly intercalating or alloying with lithium ions.

10. The material of claim 9 in which the active component has a melting point greater than 800° C.

11. The material of claim 10 in which the active component is silicon.

12. The material in claim 8 in which the conductive, elastic, carbon material is an expanded carbonaceous material.

13. The material of claim 12 in which the expanded carbonaceous material is expanded graphite.

14. The material of claim 8 in which the active component particles have an average particle size between 0.05 and 25 um.

15. A secondary Li-ion cell that uses the negative electrode material of claim 1.

16. A process for making the powder of the negative electrode material of claim 1 comprising the step of coating the active component particles capable of reversibly intercalating or alloying with lithium ions with the carbon coating layer containing an electronically conductive, elastic, carbon material capable of reversibly expanding and contracting to maintain electrical contact between the particles within an electrode matrix as the material is cycled electrochemically.

17. The process of claims 16 in which the active component is Silicon.

18. The process of claim 16 in which the step of coating the active component particles with a carbon coating layer containing the electronically conductive, elastic, carbon material includes at least the following sub-steps:
mixing the active component particles with a carbon containing material;
firing the mixture to carbonize the carbon containing material; and
expanding the carbonized material.

19. The process of claim 18 in which the carbon containing material is selected from carbon pitch or a carbon based polymer.

20. The process of claim 18 in which the active component is Silicon.

21. The process of claim 18 in which the carbonized material is at least partially graphitic.

22. The process of claim 21 in which the carbonaceous material is at least partially graphitic.

23. The process of claims 21 in which the firing temperature is between 900° C. and 1100° C.

24. The process of claim 16 in which the step of coating the active component particles with a carbon coating layer containing the electronically conductive, elastic, carbon material includes at least the following sub-steps:
physically mixing the active component particles, the already expanded carbonaceous material and a carbon containing material; and
firing the mixture to carbonize the carbon containing material.

25. The process of claim 24 in which the carbonaceous material is at least partially graphitic.

26. The process of claim 24 in which the carbon containing material is selected from carbon pitch or a carbon based polymer.

27. The process of claim 24 in which the firing temperature is between 900° C. and 1100° C.

28. The process of claim 24 in which the active component is Silicon.

29. The process of claim 16 in which the step of coating the active component particles with a carbon coating layer containing the electronically conductive, elastic carbon material includes at least the following sub-steps:
physically mixing the active component particles, a pre-intercalated carbonaceous material and a carbon containing material; and
firing the mixture to simultaneously carbonize the carbon containing material and expanding the intercalated carbonaceous material.

30. The process of claim 29 in which the carbon containing material is selected from carbon pitch or a carbon based polymer.

31. The process of claim 29 in which the firing temperature is between 900° C. and 1100° C.

32. The process of claim 29 in which the active component is Silicon.
